(19) United States
(12) Patent Application Publication
(10) Pub. No.: US 2019/0061477 A1
(43) Pub. Date: Feb. 28, 2019

(54) DEVICE FOR ADJUSTING AN AIR FLOW, AND VENTILATION DEVICE FOR A VEHICLE

(71) Applicant: Audit AG, 85045 Ingolstadt (DE)

(72) Inventors: MATHIAS WUNDERLICH, Ingolstadt (DE); CHRISTIAN FUNK, Ingolstadt (DE)

(73) Assignee: Audit AG, 85045 Ingolstadt (DE)

(21) Appl. No.: 16/076,634

(22) PCT Filed: Oct. 5, 2016
(86) PCT No.: PCT/EP2016/001649

§ 371 Date: Aug. 8, 2018

(30) Foreign Application Priority Data
Feb. 18, 2016 (DE) 102016001902.6

(51) Int. Cl. B60H 1/34

(52) U.S. Cl. CPC B60H 1/3421; B60H 2001/3478

(57) ABSTRACT

A device for adjusting an air flow exiting a vent includes a closing device to modify a strength of the air flow, and a louver mounted for pivoting about a pivot axis for modifying the flow direction. Alignment of the louver and operation of the closing device are realized via an operating element arranged on the louver. The operating element is made in two parts and includes a first operating part coupled in fixed rotative engagement to the louver, and a second operating part which is coupled with the first operating part and which can be coupled with an air flap of the closing device and can be lifted off the first operating part. The second operating part is rotatably mounted in a raised first position and coupled with the air flap so as to effect a pivoting of the air flap, when the second operating part is rotated.

The invention relates to a device for adjusting an air flow according to the preamble of claim 1, and to a ventilation device for a vehicle with at least one such device for adjusting an air flow according to the preamble of claim 8.

Devices for adjusting an air flow flowing out of a vent are known in numerous variations. The vents are hereby typically arranged at an end region of an air duct and integrated in an instrument panel or in a dashboard of a vehicle. The vents may have a housing and an outlet opening, wherein louvers can be arranged in the region of the outlet opening. In order to modify an air flow direction of the air flow flowing out of the vent, the louvers are mounted for pivoting about a first pivot axis. The alignment of the louvers can be changed by an operating element arranged on at least one louver. The operating element can hereby be arranged in midsection of the vent. A closing device can be operated via a further operating element to enable adjustment of a strength of the air flow. As an alternative, the operating element, which changes the alignment of the louvers, may also be used to effect the operation of the closing device.

Further known are corresponding ventilation devices for a vehicle, with at least an air duct, a vent, which is arranged at an end region of the air duct, and a device for adjusting an air flow which can be discharged through the vent into the vehicle interior.

DE 10 2014 200 544 A1 discloses a device for controlling an air flow from an air vent. The air flow is controlled by changing an alignment of swingable louvers, which extend in a first or in a second direction, and by controlling the amount of outflowing air by means of a closing device. The louvers extend substantially horizontally and vertically or are arranged at a certain angle in relation to each other. The device also includes at least one operating element to align the louvers running in the first direction and the louvers running in the second direction and to control the amount of outflowing air through the closing device. The operating element is accommodated in a receptacle of a control louver which extends in the first direction. When the operating element is actuated in the second direction, the louvers, which are coupled to the control louver extending in the first direction, pivot. In addition, the louvers extending in the second direction are pivoted in the first direction through actuation of the operating element. By turning the operating element, the closing device can be actuated to adjust the amount of outflowing air.

The invention is based on the object to provide a device for adjusting an air flow and a ventilation device with such a device, to enable a simple and intuitive adjustment of the air flow.

In accordance with the invention, the object is achieved by providing a device for adjusting an air flow with the features of claim 1 and by a ventilation device having the features of claim 8. Advantageous embodiments and refinements of the invention are set forth in the dependent claims.

In order to provide a device for adjusting an air flow and a ventilation device with such a device for adjusting an air flow to enable a simple and intuitive adjustment of the air flow, the operating element is made in two parts, wherein a first operating part is coupled in fixed rotative engagement to at least one first louver and a second operating part, coupled to the first operating part, can be coupled with at least one air flap of at least one closing device and can be lifted off the first operating part. In this case, the second operating part is rotatably mounted in a raised first position and coupled to the at least one air flap, so that the at least one air flap can be pivoted by rotating the second operating part.

Lifting of the second operating part is to be understood hereinafter as a movement of the second operating part along a first movement axis. The first movement axis can hereby extend perpendicular to the pivot axis of the at least one first louver, with a variation in the alignment of the at least one first louver resulting also in a modification in the alignment of the first movement axis. In order to modify the alignment of the at least one first louver, the operating element can be pivoted about a pivot axis, which substantially corresponds to the pivot axis of the at least one first louver. In this case, the first operating part can be coupled in fixed rotative engagement to the at least one first louver. The gripping surface of the operating element being gripped by a user to pivot the operating element and thereby modify the alignment of the at least one first louver, can be arranged on the first operating part or on the second operating part.

Vent is to be understood hereinafter as a unit which is arranged on an end region of an air duct and closes it. The vent can hereby include a housing which can be closed on the duct side by the closing device. An outlet opening of the vent faces the vehicle interior and includes the at least one first louver, which is swingably mounted on the housing of the vent. Using the closing device, the amount of air flow through the vent into the vehicle interior can be modified. The at least one first louver can be used to alter the direction of the outflowing air flow.

The rotational movement of the second operating part is locked in a starting position, in which the second operating part is not lifted off the first operating part. As a result, inadvertent adjustment of the airflow strength becomes advantageously impossible. In addition, different coupling mechanisms can be activated as a result of the lifting the second operating part off the first operating part, so that different configurations for coupling the second operating part to the air flap are possible. The rotational movement of the second operating part is usually about the first axis of movement.

According to an advantageous configuration of the device according to the invention, the second operating part can be installed spring-loaded, so that the second operating part can be lifted in opposition to a spring force applied by the first operating part. Advantageously, the spring force returns the second operating part to the starting position after undergoing the actuating sequence. As a result, the presence of an interfering protrusion of the second operating part can be prevented in an advantageous manner. In addition, an unwanted variation of the amount of air can be prevented after the amount of air has been modified in a desired way.

According to a further advantageous embodiment of the device according to the invention, a locking device can be activated when the second operating part is lifted off the first operating part, which locking device fixes the at least one first louver in a current position. In this way, an accidental adjustment in the alignment of the at least one first louver and thereby an inadvertent modification of the flow direction can advantageously be made difficult or prevented, when the air amount is modified by rotating the second operating part.

According to a further advantageous embodiment of the device according to the invention, the second operating part can be electrically and/or mechanically coupled to the at least one air flap. For example, the second operating part can be coupled in the first raised position with a cardan shaft, with a rotating mechanism which is activated upon rotation of the second operating part, cooperating with the cardan shaft only in the raised state to move the air flap. As an alternative, the second operating part can be coupled to an electric drive, which can be activated when the second operating part is lifted off the first operating part. By turning the second operating part about the movement axis, the duration of the activation or the change in position of the air flap can, for example, be varied. The electric drive powers hereby the air flap. An evaluation and control unit is able to determine the current position of the air flap and the air flap position desired by the rotational movement of the second operating part and to output corresponding control signals to the electric drive.

According to a further advantageous embodiment of the device according to the invention, a plurality of actuating sequences can be implemented with the second operating part, with each of the actuating sequences being associated to a corresponding operating function, so that different operating functions can be activated and executed by the second operating part. In the presence of an electrical coupling, the evaluation and control unit can ascertain the actuating sequences and output corresponding control signals. A first actuating sequence can be predefined, for example, as a one-time pulling or pushing on the second operating part. A further actuating sequence can be predefined as repeated pulling or pushing on the second operating part. As an alternative, an actuating sequence may be predefined as pulling or pushing and holding for a first time period in the first position or as pulling or pushing and holding for a second longer time period in the first position. In addition or as an alternative, a plurality of positions can be predefined along the first movement axis and can involve, for example, locking positions. For example, further positions can be provided on the first movement axis in addition to the starting position and the first position. In this case, a corresponding operating function can be activated when the second operating part reaches a certain position.

According to a further advantageous configuration of the device according to the invention, the second operating part can be rotatably mounted between a first end position and a second end position, with the air flap clearing in the first end position a maximum cross section of the air duct and closing the air duct in the second position. Advantageously, over-rotation of the second operating part can be prevented by stopping the rotary movement at the predefined end positions. As a result, the occupant can recognize on the basis of the position of the second operating part, which state the air flap has assumed.

According to a further advantageous embodiment of the device according to the invention, at least one second louver can be mounted for swinging about a second pivot axis and the alignment of the at least one second louver can be changed via the first operating part. The second pivot axis can hereby extend perpendicular to the first pivot axis. For example, the first operating part can be shifted on the at least one first louver in order to modify the alignment of the at least one second louver. In this case, the at least one second louver can be arranged behind the at least one first louver. Furthermore, the at least one second louver may extend substantially perpendicular to the at least one first louver.

According to an advantageous configuration of the ventilation device according to the invention, an air flap of a closing device of a corresponding vent can be adjusted, when using a first actuating sequence of the second operating part by the subsequent rotation of the second operating part.

According to a further advantageous embodiment of the ventilation device according to the invention, the air flaps of a plurality of associated closing devices can be adjusted by the rotation of the second operating part, when a second actuating sequence of the second operating part is used, with the closing devices being assigned to different vents. For example, the actuating element, with which the second actuating sequence can be executed, can be arranged in the vent, which is arranged in the access area of the driver. Advantageously, the driver can thereby adjust the amount of air flow of several existing vents with one operation.

An exemplified embodiment of the invention is illustrated in the drawing and will be explained in greater detail in the following description. In the drawing same reference signs designate components or elements that perform the same or analogous functions. It is shown in:

FIG. 1 a schematic sectional view of an exemplified embodiment of a device according to the invention for adjusting an air flow,

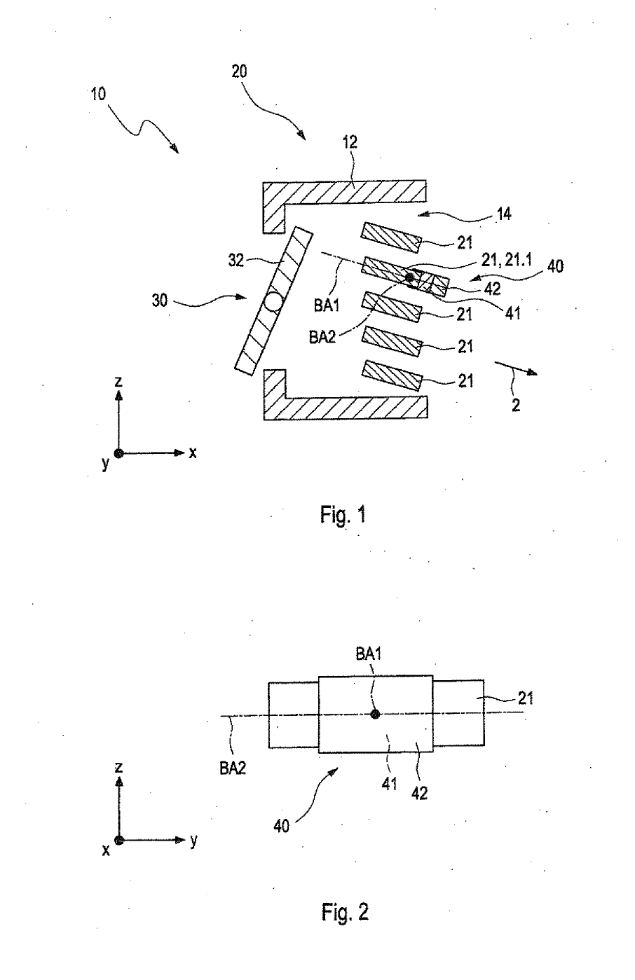

FIG. 2 an enlarged schematic front view of a first louver with an operating element of the device according to the invention for adjusting an air flow of FIG. 1 in a starting position,

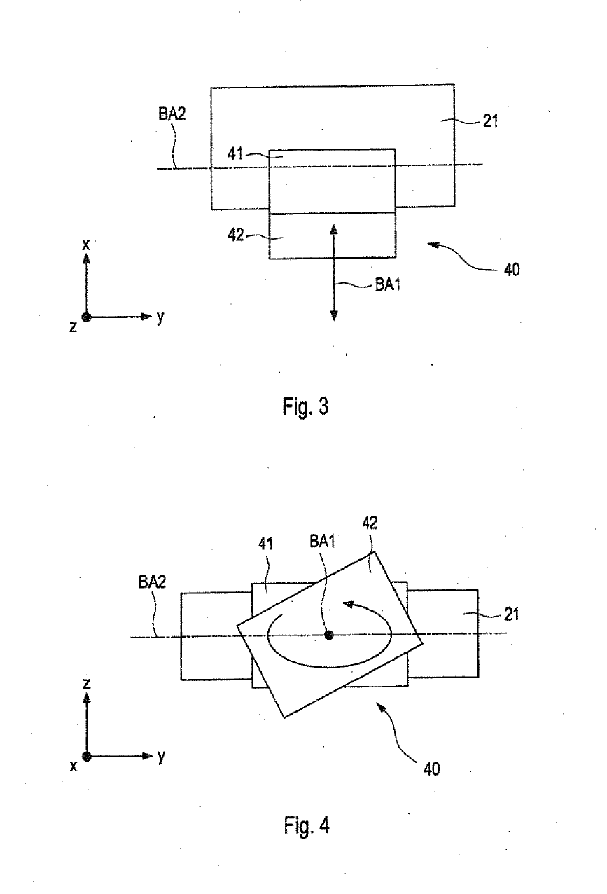

FIG. 3 an enlarged schematic plan view of the first louver of FIG. 2, and

FIG. 4 an enlarged schematic front view of the first louver with the operating element FIGS. 2 and 3 in a first position.

As is apparent from FIGS. 1 to 4, a device 20 for adjusting an air flow 2, which flows out of a vent 10, includes at least one closing device 30, by which a strength or amount of the air flow 2 can be modified, and at least a first louver 21, 21.1. The at least one first louver 21, 21.1 is mounted for pivoting about a first pivot axis for modifying the flow direction, with the alignment of the at least one first louver 21, 21.1 and the operation of the closing device 30 being implemented via an operating element 40. The operating element 30 is hereby arranged at least on a first louver 21, 21.1.

According to the invention, the operating element 40 is made of two parts, with a first operating part 41 being coupled in fixed rotative engagement to at least one first louver 21, 21.1, and a second operating part 42 which is coupled to the first operating part 41 and can be coupled to at least one air flap 32 of the at least one closing device 30 and configured such that it can be lifted off the first operating part 41, wherein the second operating part 42 is rotatably mounted in a raised first position and coupled to the at least one air flap 32, so that the at least one air flap 32 is pivoted as the second operating part 42 is rotated.

A ventilation device, not shown in greater detail, for a vehicle includes at least one air duct, the vent 10, which is arranged at an end portion of the air duct, and the device 20 for adjusting the air flow 2, which can be discharged through the vent 10 into the vehicle interior.

As is further apparent from FIG. 1, the vent 10 includes in the shown exemplary embodiment a housing 12 with an outlet opening 14. Several first louvers 21 are arranged in the region of the outlet opening 14. The operating element 40 is arranged on a control louver 21.1. The louvers 21, 21.1 extend substantially in vehicle transverse direction y and can be pivoted about a pivot axis in vehicle transverse direction y. By pivoting the first louvers 21, 21.1, the air flow 2 can be directed upwards or downwards along the vehicle vertical axis z. The first louvers 21 are coupled with the control louver 21.1 via a not shown first coupling device. The first louvers 21 are pivoted by the first coupling device, when the control louver 21.1 is pivoted by the operating element 40. The first operating part 41 is connected in fixed rotative engagement to the control louver 21.1, so that the operating element 40 can be pivoted about the pivot axis of the first control louver 21.1 in order to pivot the first louvers 21. In the illustrated exemplary embodiment, the second louver 21 from above is configured as control louver 21.1. There is, however, also the possibility to configure another louver 21 or several louvers 21 as control louver 21.1. The operating element 40 may have a not shown gripping surface for the user on the first operating part 41 or on the second operating part 42.

As is further apparent from FIGS. 1 to 4, the operating element 40 can be moved along a first movement axis BW1. In the illustrated exemplary embodiment, the first movement axis BW1 is arranged perpendicular to the pivot axis of the control louver 21.1. When moving the control louver 21.1 in direction of an occupant, the second operating part 42 is lifted off the first operating part 41. Upon rotation of the second operating part 42 about a first rotation axis, which corresponds to the first movement axis BW1, the air flap 32 can be pivoted. The second operating part 42 is configured spring-loaded in the illustrated exemplary embodiment, wherein the second operating part 42 can be lifted off the first operating part 41 in opposition to a spring force. As a result, the second operating part 41 returns to the starting position after the operating sequence and does not interferingly project.

As is further apparent from FIG. 1, the air flap 32 is arranged between the air duct and the vent 20. In the illustrated exemplary embodiment, the air flap 32 is configured as a pivotable single-part flap. In an alternative exemplary embodiment, the air flap may be embodied as a so-called “butterfly wing flap”. The second operating part 42 of the operating element 40 can be electrically or mechanically coupled to the at least one air flap 32. In addition, a combination of electrical and mechanical coupling is conceivable. In a not shown mechanical coupling, when the second operating part 42 is lifted, a cardan shaft may interact with the second operating part 42 and power the air flap 32 via corresponding bevel gears. In the case of an electrical coupling, when the second operating part 42 is lifted, a not shown electric drive can be activated for pivoting the air flap 32. The second operating part 42 is rotatably mounted between a first end position and a second end position, with the air flap 32 clearing a maximum cross section of the air duct in the first end position and closing the air duct in the second position. The second operating part 42 cannot be rotated beyond the predetermined end positions. Thus, the maximum rotational movement can be predefined as an angle range which is, for example, less than 180°. In addition, several actuating sequences can be implemented with the second operating part 42, with each of the actuating sequences being associated to a corresponding operating function, so that different operating functions can be activated and executed by the second operating part 42. A first actuating sequence may, for example, be defined as a one-time pulling or pushing on the second operating part 42. A further actuating sequence can be configured as repeated pulling or pushing on the second operating part 42. As an alternative, another actuating sequence can be configured as pulling or pushing and holding for a first time period in the first position or as pulling or pushing and holding for a longer second time period in the first position. An evaluation and control unit can match the executed actuating sequence with stored actuating sequences and activate or execute a corresponding operating function assigned to the detected actuating sequence. In addition or as an alternative, several positions can be predefined along the first movement axis BW1, which can be implemented, for example, as locking positions. Thus, for example, further positions can be provided on the first movement axis BW1 in addition to the starting position and the first position. A corresponding operating function can hereby be activated, when the second operating part 42 reaches a specific position. For example, upon application of a first actuating sequence of the second operating part 42, the subsequent turning of the second operating part 42 can adjust the air flap 32 of the closing device 30 of a corresponding vent 10. As an alternative or in addition, when a second actuating sequence of the second operating part 42 is used, the air flaps 32 of several closing devices 30 can be adjusted by the subsequent rotation of the second operating part 42, with the closing devices 30 being arranged in different vents 10.

According to an alternative not shown exemplary embodiment, at least one second louver extending in a second direction can be mounted for pivoting about a second pivot axis in the region of the outlet opening 14. In a preferred exemplary embodiment, the second louvers are arranged behind the first louvers 21 as viewed from the vehicle interior. Furthermore, the second louvers can extend preferably in the vehicle vertical direction z, with the second pivot axis extending in the vehicle vertical direction z. By pivoting the second louvers, the air flow can be directed in the vehicle transverse direction y to the left or to the right. In order to pivot the second louvers, the first operating part 41 of the operating element 40 can be shifted along a second movement axis BW2 on the first control louver 21.1. By moving the first operating part 41 along the second movement axis BW2, the second louvers can be pivoted via a not shown second coupling device.

According to a further alternative not shown exemplary embodiment, a locking device can be activated when lifting the second operating part 42 off the first operating part 41, to secure the at least one first louver 21, 21.1 in a current position. In a configuration with first and second louvers, also the second louvers can be secured by the locking device. In this case, for example, by securing the control louver 21.1 or by securing the first coupling device or the second coupling device, unintentional pivoting of the first louvers 21, 21.1 or the second louvers is prevented or made more difficult, when turning the second operating part 42. In a configuration of the invention in which several actuating sequences can be executed with the second operating part 42, a third actuating sequence for activating the locking device can be provided.

### LIST OF REFERENCE SIGNS

2 airflow
10 vent
12 housing
14 outlet opening
20 air flow adjusting device
21.1 control louver
21 first louver
22 second louver
30 closing device
32 air flap
40 operating element
41 first operating part
42 second operating part
BA1, BA2 movement axis

What is claimed is:

1.-10. (canceled)

11. A device for adjusting an air flow exiting a vent, said device comprising:
a closing device configured to modify a strength of the air flow and including an air flap;
a first louver mounted for pivoting about a first pivot axis for modifying a flow direction of the air flow; and
an operating element configured to align the first louver and to operate the closing device, said operating element being made in two parts including a first operating part which is coupled in fixed rotative engagement to the first louver, and a second operating part which is coupled with the first operating part and configured for coupling with the air flap of the closing device, said first and second operating parts being arranged such that the second operating part is liftable off the first operating part to assume a raised position in which the second operating part is rotatably mounted and coupled to the air flap so that a rotation of the second operating part causes a pivoting of the air flap.

12. The device of claim 11, wherein the second operating part is spring-loaded to apply a spring force such that lifting of the second operating part off the first operating part is implemented in opposition to the spring force.

13. The device of claim 11, further comprising a locking device which is activated when the second operating part is lifted off the first operating part, to secure the first louver in a current position.

14. The device of claim 11, wherein the second operating part is electrically and/or mechanically coupled to the air flap.

15. The device of claim 11, wherein the second operating part is configured to enable implementation of several actuating sequences, with each of the actuating sequences being associated with a corresponding operating function.

16. The device of claim 11, wherein the second operating part is rotatably mounted between a first end position in which the air flap clears a maximum cross section of an air duct for the air flow, and a second end position in which the air duct is closed.

17. The device of claim 11, further comprising a second louver mounted for pivoting about a second pivot axis which extends perpendicular to the first pivot axis, said operating element being configured to adjust an alignment of the second louver.

18. A ventilation device for a vehicle, comprising:
an air duct;
a vent arranged at an end region of the air duct; and
a device for adjusting an air flow exiting the vent into a vehicle interior, said device including a closing device configured to modify a strength of the air flow and including an air flap, a first louver mounted for pivoting about a first pivot axis for modifying a flow direction of the air flow, and an operating element configured to align the first louver and to operate the closing device, said operating element being made in two parts including a first operating part which is coupled in fixed rotative engagement to the first louver, and a second operating part which is coupled with the first operating part and configured for coupling with the air flap of the closing device, said first and second operating parts being arranged such that the second operating part is liftable off the first operating part to assume a raised position in which the second operating part is rotatably mounted and coupled to the air flap so that a rotation of the second operating part causes a pivoting of the air flap.

19. The ventilation device of claim 18, wherein the second operating part is spring-loaded to apply a spring force such that lifting of the second operating part off the first operating part is implemented in opposition to the spring force.

20. The ventilation device of claim 18, wherein the device includes a locking device which is activated when the second operating part is lifted off the first operating part, to secure the first louver in a current position.

21. The ventilation device of claim 18, wherein the second operating part is electrically and/or mechanically coupled to the air flap.

22. The ventilation device of claim 18, wherein the second operating part is configured to enable implementation of several actuating sequences, with each of the actuating sequences being associated with a corresponding operating function.

23. The ventilation device of claim 18, wherein the second operating part is rotatably mounted between a first end position in which the air flap clears a maximum cross section of an air duct for the air flow, and a second end position in which the air duct is closed.

24. The ventilation device of claim 18, wherein the device includes a second louver mounted for pivoting about a second pivot axis which extends perpendicular to the first pivot axis, said operating element being configured to adjust an alignment of the second louver.

25. The ventilation device of claim 18, wherein upon application of a first actuating sequence of the second operating part, a subsequent rotation of the second operating part enables adjustment of the air flap of the closing device of the vent.

26. The ventilation device of claim 18, further comprising a plurality of said closing device and a plurality of said vent, with the closing devices and the vents being placed in one-to-one correspondence, wherein upon application of a second actuating sequence of the second operating part, a subsequent rotation of the second operating part enables adjustment of the air flaps of the closing devices.
